(19) United States
(12) Patent Application Publication
(10) Pub. No.: US 2017/0146133 A1
(43) Pub. Date: May 25, 2017

(54) Valve for fire protection systems and methods of control therefore

(71) Applicant: Globe Fire Sprinkler Corporation, Standish, MI (US)

(72) Inventors: Thomas Edwin Archibald, Midland, MI (US); Yoram Ringer, Providence, RI (US); Brian Dean Spicer, Standish, MI (US); Larry Arthur Robinson, Turner, MI (US); Shalom Wertsberger, Penfield, NY (US)

(21) Appl. No.: 15/344,737

(22) Filed: Nov. 7, 2016

Related U.S. Application Data
(60) Provisional application No. 62/257,486, filed on Nov. 19, 2015.

(51) Int. Cl. F16K 1/20; A62C 35/68; F16K 31/44

(52) U.S. Cl. CPC F16K 1/2007; F16K 1/2042; F16K 31/44; A62C 35/68

(57) ABSTRACT

A valve for control of fluid flow in a fire protection system, having a body forming a fluid path between an inlet and an outlet connected via a seat, and a clapper with a bottom sealing surface and a top with a latch abutment portion. The valve further comprises an arm coupled to the valve body about a hinge point and having a closure end with an optional roller or ball. The arm is movable to engage the clapper and maintain the clapper closed, or to disengage and allow the clapper to open. The arm is disposed such that the opening force on the clapper is transferred primarily directly to the body, providing large closing force against the clapper, requires relatively small force to dislodge the arm, and in many embodiments substantially isolates the closing force from the force required to dislodge the arm.

### FIELD OF THE INVENTION

The present invention is directed generally to fire protection systems and more particularly to improved valves in fire protection systems, and to methods of controlling thereof.

### BACKGROUND OF THE INVENTION

Many fire protection systems use flow valves to control the flow of amounts of water or other fire extinguishing agent (which, for brevity, will be equivalently related to as water in these specifications) to a fluid distribution arrangement such as sprinklers, nozzles, and the like, which distribute the water to where they are needed to extinguish a fire. Typically such a flow control valve has a valve body having a chamber with an inlet and an outlet. The chamber forms at least a portion of a waterway which is a path for fluid flow from the inlet to the outlet. The waterway has a sealing port defined therein, The valve has a moveable closure member positioned in the waterway. The closure member is movable between a closed position to at least one open position. When the closure member is in the closed position the closure member substantially obstructs (notwithstanding unintentional leaks and the like) fluid flow from the inlet to the outlet, while in the open position the closure member presents relatively low obstruction of such fluid flow. Any number of intermediate closure member positions exist between a closed and open state, but in most cases those positions are transitory between the open and closed states, and as such would be considered in theses specifications as open states. The valve is considered closed when the closure member is in closed position, and open when the closure member is not in the closed position, including any intermediate states between the closed and the fully open position.

Operating such valves, especially when they are under high pressure differential, require large forces or large movement to change the valve from closed to open state, and/or to an intermediate state. To reduce the forces required to transition the valve from a closed to open state (and in certain cases from open to closed state, and/or to some intermediate state therebetween) controlled valves were developed. Controlled valves have a valve actuator mechanism which applies smaller forces in a judicial manner to control the movement of the closure member in cooperation with other forces operating thereupon.

In certain valves known colloquially as ‘clapper’ type valves, the closure member comprises a hinged member having a seal surface. In the closed position the seal surface is urged against a valve seat surrounding the sealing port, and blocks fluid flow from the inlet to the outlet. In the open position, the closure member hereinafter known as the clapper rotates about its hinge away from the seat, and thus allows fluid flow from the inlet to the outlet.

The following description relates to a valve which is exposed to fluid pressure from the inlet, and when the valve is in the closed state the clapper by blocking fluid flow prevents communication of pressure from the inlet to the outlet. Most common clapper type valves are installed in an orientation that will urge the clapper to close due to gravitational forces, lacking other forces. Other mechanisms are also known to apply forces that will urge the clapper to the closed position, but for brevity such mechanisms would be considered equivalent to gravity, as their function is similar.

For clarity of the descriptive terms such as ‘upper’ and ‘lower’, ‘above’, ‘below’, ‘sideways’, and the like, are applied to describe relative disposition, locations, and orientations of various components. Such terms should be construed as relating of a valve disposed in a vertical position such that the outlet is above the inlet. Thus by way of example the term ‘upper chamber’ relate to a volume bounded by the valve body from the valve outlet to a plane dissecting the valve body at or about the sealing port, while the ‘lower chamber’ relate to a volume bounded by the valve body from the inlet to a plane dissecting the valve body. Notably, the relative positions are descriptive and relative to a valve in the above described orientation and modifying the valve orientation would not change the disclosed relative structure. It is however noted that the sealing port may not be perpendicular to the inlet and the outlet.

In a system where the valve is disposed between a pressurized fluid supply and the distribution network, the state where the valve is closed is equivalently referred to as standby state, and the state where the valve is open is referred to as activated state. Reliable transitioning between standby and activated state during fire is perhaps the demand of highest importance of such valve, followed by avoiding false activation thereof.

When the valve is in standby state, inlet fluid pressure exerts an opening force which acts in an opening force direction against the clapper. The opening force may be very large, and without a closing actuator mechanism to oppose it, would overcome the gravitational force applied to the clapper. The closing mechanisms commonly utilize a clapper holding member to effect a closing force against the clapper. The clapper holding member may be actuated directly by an actuator such as a piston, a screw, a diaphragm, and the like, or may be coupled indirectly to a control mechanism, often using mechanical advantage to control the actuation of the closing member. Many types of actuating mechanism are known, such as diaphragms, electric solenoids, electric, pneumatic, or hydraulic motors and pistons, and the like.

Valves often utilize mechanical advantage whereby the relatively small forces generated by the control mechanism are multiplied by mechanical advantage thereby offsetting the large opening forces operating on the clapper in standby state. These valves sometimes experience restriction of movement due to changes stemming from exposure to environmental or other factors that may cause resistance to movement. By way of example, corrosion or accumulations of adherent deposits may impede component motion, and such effects are particularly harmful when multiplied by mechanical advantage. Certain valves use resilient materials, and such resilient materials experience reduction in resilience over time. When such reduced resilience occurs in an element controlling valve operations, especially when said effect is multiplied by mechanical advantage, resistance to opening increases significantly.

Other valves comprise elements that utilize mechanical advantage to hold a flow control element closed either by having pressure operate over a large area as in the case of the diaphragm, or by exerting force to a component or components having a large range of movement. Such large area, or range of movement increase the overall volume of a valve making it large and/or heavy, and making the valve more difficult to transport and install.

A common problem point in existing design is the interface where the retainer latch, retainer lever, piston, screw, or other similar retainer member abuts the clapper. At that area the retainer member must apply large force to counter the large clapper opening force, and accordingly releasing the retainer member requires significant force which must be effected by the control mechanism. As described supra, prior art valves are susceptible to corrosion, deposits, loss of resilience, and similar effects, and attempts to ameliorate such problems require large size and weight increases. Moreover, most retainer members utilize mechanical advantage to achieve significant force, and oftentimes large range of motion, which slows down valve opening, and which requires large actuator.

When transitioning between standby state and deployed state, many of the known retaining members move generally in a direction which is opposite to the direction of the force the retainer member applies to the clapper, in order to affect fluid flow. In certain other known valves the retainer member is a catch which is rotated away from the clapper but the retainer member still moves firstly in the direction opposite the closing force, in order to affect flow. In those known valves the actuating mechanism of the retainer member must bear at least a significant portion of the opening force. In some known valves mechanical advantage is used to reduce those forces operating on the control mechanism, but as discussed above, such valves suffer several disadvantages such as slower actuation, and the effects of even small resistance is amplified which reduces the valve reliability.

There is therefore a clear, yet heretofore unanswered, need for a reliable valve and valve control mechanism which will overcome the shortcoming of known valves. Different aspects of the present invention are directed to those ends.

### SUMMARY

To alleviate the problem of large forces operating on the control mechanism of the retainer member, aspects of the present invention utilize retainer member which transfers most if not all of the opening force it counters to the valve body, while allowing the actuating mechanism which controls the retainer member to act against a small portion of the opening force. In some embodiments of the invention the actuating mechanism is disposed substantially at right angle to the closing force, reducing the opening force component operating thereon to negligible levels. As the actuating mechanism only needs to urge or release the retainer member using a relatively small force, fast actuation can be provided by small actuating force and corresponding smaller actuating mechanisms.

Thus, in an aspect of the invention, there is provided a valve for control of fluid flow in a fire protection system, the valve comprises a valve body defining a lower chamber having an inlet and an upper chamber having an outlet, and a valve seat disposed in the valve body. The valve seat surrounds a sealing port. A valve closure member, hereinafter denoted as a clapper, is disposed within the valve body, and has a bottom and a top, the bottom having a sealing surface, and the top having an abutment portion. The clapper is coupled to the valve body by a clapper hinge and is pivotally rotatable thereabout from a closed position where the sealing surface contacts the seat sufficiently to impede fluid flow from the inlet to the outlet. A retainer member hereinafter described as an arm is rotatably coupled to the valve body at an arm anchored end about a hinge point, the arm has a closure end away from the hinged end, and the arm is movable between a disengaged state and an engaged state, wherein while the clapper is in the closed state the closure end contacts the clapper abutment portion in at least one abutment point, defining an arm force extending in a direction from the arm anchor point towards the abutment point, for maintaining the clapper in the closed position. An actuator is coupled to the arm for urging the arm from the engaged state to the disengaged state. In certain embodiments the actuator urges the arm from the disengaged state to the engaged state. When the clapper is in the closed state the abutment point lies in a geometrical plane parallel to the seat. For ease of understanding the plane is assumed to be separating the lower chamber on one side thereof from the upper chamber on the opposite side thereof. The rotational direction of the clapper from the closed position is into the upper chamber. In many embodiments the arm anchor point is disposed in the upper chamber, providing several advantages to this aspect of the invention, as described below.

Notably in most embodiments the geometrical plane is somewhat above the sealing port, and thus, strictly stating, the area below the plan may include some physical portions of what may ordinarily be defined as the upper chamber, and the lower chamber, which ordinarily may be defined as extending to the sealing port, does not necessarily extend all the way to the geometrical plan, however for brevity the division between the chambers for purposes of location and/or orientation of the elements, angles, or force directions is made somewhat arbitrarily by the geometrical plan disclosed and defined above. The term ‘urging’ and its various inflections should be extended to allow pushing, pulling, releasing, and/or rotating, and the like.

Some embodiments locate the arm anchor point substantially in-line with the abutment point, optionally approximately parallel with a line from the inlet to the outlet. This arrangement offers great strength and reduced control forces.

In the engaged state, those embodiments translate substantially all of the opening force, imparted by the clapper to the arm closure end, to the arm anchor point on the valve body, and a substantially orthogonal actuating force is utilized to either engage or disengage the closure end of the arm, imparting sideways movement thereto. As the actuating force is substantially orthogonal to the opening force, the opening force component thereupon is negligible or nil.

When fluid having pressure is supplied to the inlet when the clapper is in the closed position, the fluid exerts on the clapper an opening force in an opening force direction. In some embodiments the angle between the opening force direction and the arm force direction or an extension thereof is smaller than 45 degrees. Stated differently, the included angle between the a line congruently extending along the opening force on both sides of the clapper, and the arm force or an extension of the arm force that may be translated laterally as required to meet such line, will form an included angle smaller than 45°. Certain embodiments may utilize smaller angles, such as smaller than 30 degrees, 15 degrees, 5 degrees, or smaller. Embodiments where the angle between the arm force and the opening force are smaller than 45°, especially in embodiments where the abutment point surface is angled to the opening force, the effective angle between the opening force and the arm force may be considered to be zero and the forces are considered parallel. In certain embodiments the actuator imparts an actuator force to the arm between the arm anchor point and the abutment point. It is further noted that in some embodiments the actuator imparts the actuator force only for transitioning the arm form engaged to disengaged state, and in other embodiments the actuator force is imparted continuously to maintain the arm in the engaged state when the clapper is closed.

In some embodiments the arm closure end comprises a roller which is the portion of the arm in contact with the clapper abutment portion, and the abutment point is at least one point along the line of contact between the roller and the abutment portion of the clapper. In certain embodiments the arm closure end comprises a ball and the ball is the contact point between the arm and the clapper abutment portion. In certain embodiments the arm comprises an over-the-center locking hinged lever comprising two hinged parts and a stop limiting the parts movement in one direction, such that an over-the-center swing of the hinged parts towards the stop will render the arm rigid, and over-the-center swing of the hinged parts in a direction away from the stop will allow the lever to hinge fully with little or no impediment. Such arrangement offers an arm which is fully locked at a small angle between the two lever parts, and an easy rotation between the two lever parts when the lever parts are moved over the hinge center in the opposite direction.

Optionally in some embodiments the abutment portion is angled to the sealing surface. In those embodiments the angle is commonly smaller than 45 degrees, and in some cases is between 10 and 30 degrees. In other embodiments the abutment portion is parallel to the sealing surface.

Optionally the arm further comprises an arm extension extending away from the arm anchor point, beyond the closure end. The arm extension is offset from the abutment point so as not to interfere with the clapper. The actuator is coupled to the arm via the arm extension. Such arrangement will reduce the forces required to actuate the arm, and thus allow using a smaller actuator.

In optional embodiments when the clapper is in the closed state the abutment portion lies above the geometrical centroid of a plane defined by the valve seat, and in certain embodiments the abutment point lies in a line perpendicular to, and extending through, the geometrical centroid of the valve seat plane. Further optionally a lateral waterway enlargement is provided, for avoiding waterway narrowing if the clapper fails to clear the straight waterway between the valve inlet and the valve outlet.

In another aspect of the invention, there is provided a valve for control of fluid flow in a fire protection system, the valve comprises a valve body defining a valve chamber forming a fluid path between a valve inlet and a valve outlet, the chamber having a seat disposed in the fluid path, the valve comprises a clapper having a bottom and a top, the bottom having a sealing surface, and the top having a abutment portion, the clapper being coupled to the valve body by a clapper hinge and being pivotally rotatable thereabout from a closed position where the sealing surface contacts the seat sufficiently to impede fluid flow from the inlet to the outlet. The valve further comprises a hinged arm movably coupled to the valve body about a hinge point and having a closure end. Optionally the closure end having a roller coupled thereto. The arm is movable between a disengaged state and an engaged state wherein while the clapper is in the closed state the closure end contacts the abutment portion at least by the roller, for maintaining the clapper in the closed position. Like other embodiments, the valve further comprises an actuator coupled to the arm for urging the hinge from the engaged state to the disengaged state. In certain embodiments the actuating mechanism is capable of urging the arm from the disengaged state to the engaged state.

In some embodiments the arm comprises at least a first and a second elongated sections coupled by an arm hinge therebetween and rotatable thereabout. A portion of the first arm section distal to the arm hinge being rotatably coupled to the valve body about an arm anchor point, the arm having a closure end at a portion of the second arm section distal to the arm hinge. Optionally with such arm arrangement, the arm is disposed in an ‘over-center’ state when the arm is engaged, which implies that when the actuator urges the arm to the disengaged state, the hinge center crosses the arm force, i.e. a line extending between the arm anchor point and the abutment end. Optionally a roller is disposed at the abutment end.

As described above, in this context, the term ‘urging’ and its various inflections should be extended to allow pushing, pulling, releasing, and/or rotating, and the like.

### SHORT DESCRIPTION OF DRAWINGS

Some embodiments of the valve are described herein with reference to the accompanying drawings. The description, together with the figures, makes apparent to a person having ordinary skill in the art how the teachings of the disclosure may be practiced, by way of non-limiting examples. The figures are for the purpose of illustrative discussion and no attempt is made to show structural details of an embodiment in more detail than is necessary for a fundamental and enabling understanding of the disclosure. For the sake of clarity and simplicity, some objects depicted in the figures are not to scale.

FIG. 1 depicts a cross section of one embodiment of the valve shown in standby state.

FIG. 1A depicts certain forces operating on the abutment point of the valve in FIG. 1, and

FIG. 1B depicts a side cross section of the embodiment shown in FIG. 1.

FIGS. 2A, 2B, and 2C depict clapper and arm arrangements according to some optional embodiments

FIGS. 3A, and 3B depict clapper and arm arrangements according to some embodiments that utilize a roller

FIGS. 4A, 4B, and 4C are enlarged views of the clapper/arm abutment area, showing certain optional embodiments

FIG. 5A depict cross sectional side view of the valve in an open state and FIG. 5B depicts a cross sectional side view of valve in an open state with a latch holding the clapper open.

FIG. 6 depicts an embodiment of an arm with an arm extension.

FIG. 7 depicts an arm/clapper interface where the roller is disposed on the clapper

FIG. 8 depicts an example of the family of embodiments where the closure arm anchor point is below the clapper, utilizing a roller.

FIGS. 9A and 9B depict an embodiment with over-the-center hinged closure arm

FIGS. 10 A-C depicts an embodiment which offers reduced load on the clapper hinge.

### DETAILED DESCRIPTION

The following describes certain embodiments by way of example to facilitate understanding of various aspects of the invention, however the invention should not be construed to be limited to only the described examples.

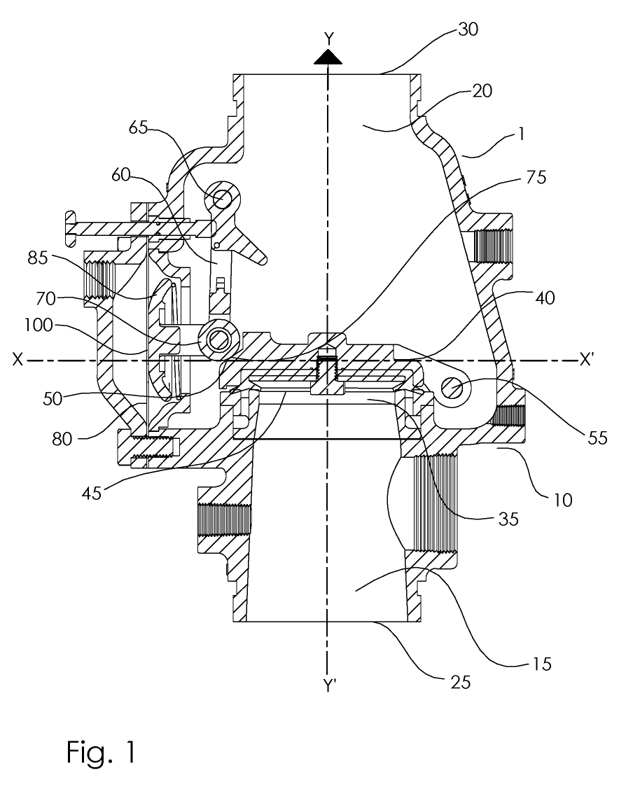

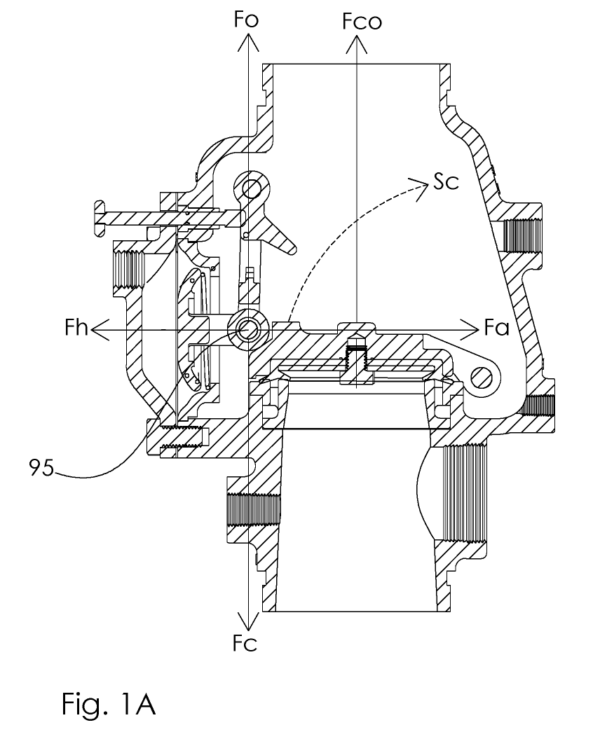

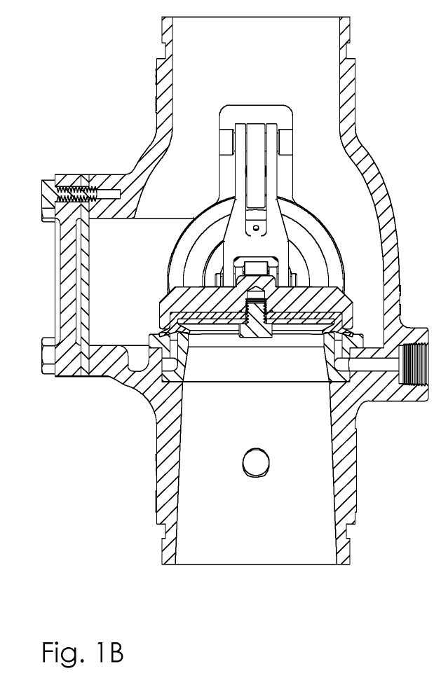

FIG. 1 depicts a cross section of a valve 1 in accordance with some aspects of the present invention, and FIG. 1B depicts a side view thereof. The valve has a body 10 which defines a valve chamber. The valve chamber may be considered as a single chamber extending within the valve body from the valve inlet 25 to the valve outlet 30, but is more conveniently considered as divided into an upper chamber 20 and lower chamber 15. The valve body has a seat 35 disposed therein.

The directional terms ‘up’, ‘down’, ‘left’, ‘right’ and their conjunctions and relations, such as upward, above, lower, below, horizontal, and vertical should be construed at their ordinary meaning, when the direction indicated by the arrow marked close to the letter Y on the vertical axis Y-Y′ axis, indicates the up direction.

A clapper 40 is coupled to the valve body 10 by a clapper hinge 55, and is capable of pivotally rotating about the hinge, into the upper chamber

The clapper has top portion and a bottom portion. The bottom portion has a sealing surface 45, which is disposed to contact the seat substantially all around its perimeter, and the interface between the sealing surface and the seat forms a seal sufficient to impeded fluid flow from the lower chamber to the upper chamber, or stated differently, to prevent fluid from flowing in the fluid path between the valve inlet and the valve outlet. The position in which the clapper impedes fluid flow between the valve inlet and outlet is referred to as the clapper closed position. This interface between the seat and the sealing surface is considered to define the ‘seat’ in these specifications, as this is the functional and active part of forming the seal between the upper and lower chambers.

In these specifications unintentional leaks and imperfections and parasitic forces such as friction, elasticity, and the like, are considered negligible in a properly operating valve, and shall not be considered unless specifically stated otherwise.

The clapper may rotate into the upper chamber into any number of other positions, until it is stopped by the valve body or by other stop, at which point it is considered to be in the fully open position. Arc Sc in FIG. 1A indicates the general swing of the clapper. The clapper may assume any number of intermediate positions between the closed and a fully open positions, but generally any position where fluid is intentionally allowed to flow through the clapper/seat interface is considered open

The valve chamber forms a controlled fluid flow path from the valve inlet, and while the valve is in an open state, via the lower chamber, passing the seat, via the upper chamber, and continuing to the valve outlet.

When the valve is deployed in a firefighting system, fluid under pressure is coupled to the valve inlet, and the clapper in its closed position prevents the fluid from flowing past the clapper-seat interface to the valve outlet, thus the firefighting system is in standby mode, and the valve is said to be in closed state, or equivalently, in standby state.

When in standby state the fluid at the lower chamber exerts an opening force on the clapper. The opening force magnitude is a function of the area of the sealing force and the fluid pressure. The combined opening forces operating on the whole surface of the clapper exposed to fluid pressure, may be represented by an equivalent force vector (denoted hereinafter as central vector or F_{CO}) located at the centroid of all opening forces operating on the clapper. In general, such central vector F_{CO} would be located at the geometrical centroid of the seat and directed perpendicular thereto in the opening direction. By way of example in FIG. 1A, while the pressure is distributed across the sealing surface, a portion of the opening force F_{CO} is acting on the clapper hinge 55, and a component of the force, depicted by the vertical line Fₒ, acts on the clapper end opposite the hinge in the opening direction. The force F_{O} is the vertical component of F_{co} at the abutment point on the rotation arc S_{c} of the clapper at the instant of transition from the closed state. The opening force F_{O} may be very high and in most cases far exceeds the force required to rotate the clapper to an open position against the force of gravity or any spring, and thus a closing force is required to counteract the opening force, and maintain the clapper in the closed state. It is noted that the location of F_{co} may differ from the geometrical centroid if the bottom surface of the clapper is not planar, and those skilled in the art would readily recognize how to calculate the equivalent vector using well known mechanical physics principles.

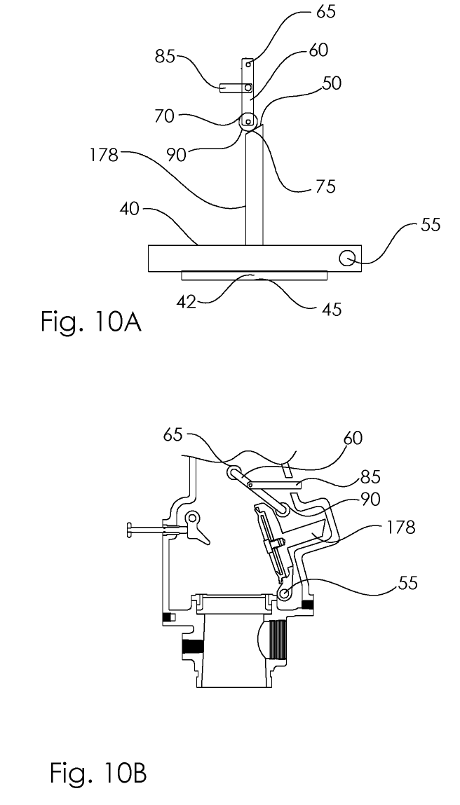

The clapper top has an abutment portion 50, where such closing force F_{c} is applied. The abutment portion is most often disposed on the portion of the clapper distal from the clapper hinge, to allow reduction of the magnitude of the closing force and the force operating on the hinge, however, in certain embodiments, as depicted for example by FIG. 9, the abutment portion is placed so as to reduce the portion of the F_{CO} force which is applied to the clapper hinge 55.

A retainer member embodied as an arm 60 is provided to selectively apply the closing force Fc. The arm in the depicted embodiment is movably anchored directly or indirectly to the valve body, such that the arm may hinge about a hinge point 65. The arm is movable between a disengaged state, and an engaged state in which the arm acts against at least a portion of the clapper opening force denoted by Fₒ. The arm extends to a closure end 70, which is a portion of the arm extending away from the arm anchor point 65 towards the clapper abutment portion when the clapper is in the closed position, and the arm is engaged. The arm closure end contacts the clapper abutment portion in at least one abutment point 75. The term ‘abutment point’ should be construed as an area of interface between the clapper in the closed position and the arm closure end in the engaged state, and does not necessitate a single geometrical, dimensionless point. Generally the point of contact between the arm closure end and the clapper abutment portion closest to the clapper hinge is considered as an abutment point, as it counteracts the highest opening force countered by the arm. However more than one abutment point may exist with pressure applied therethrough between the clapper abutment portion and the arm closure end.

When the arm is engaged with the clapper abutment portion, the arm counteracts the opening force or a component thereof, operating at the abutment potion, and thus the arm may be considered to apply an arm closing force. Often the arm closing force is equivalent or closely related to the closing force, and at least a large component of the arm closing force is translated into the closing force F_{C} which acts against the opening force F_{O}, and thus against the central force F_{co} or a component thereof if the arm is engaged away from the centroid or the seal.

A geometrical plane parallel to the seat and containing the abutment point divides the valve body to the upper chamber 20, which is the chamber into which the clapper rotates when transitioning from the closed position, and the lower chamber 15 which is directed from the dividing plane towards the valve inlet, opposite the up-arrow on the Y′-Y axis. The geometrical plane is depicted in FIG. 1 by the dashed line extending from X to X′

FIG. 1A depicts simplified force distribution about the abutment point in the valve of FIG. 1. While other latching and abutments arrangements are disclosed below, the forces or their equivalents generally operate in similar directions, but may be translated to other location. Moreover, while certain of the depicted forces may be equivalents of various force components, basic force equivalents will result in forces similar to the depicted forces. Notably, the depicted force indicate only directions, and are not necessarily proportional to the relative or absolute magnitude of the forces or force components.

In certain embodiments, the arm anchor point 65 is disposed in the upper chamber. In a number of those embodiments the anchor point is disposed substantially above the abutment during standby state, such that the arm anchor point 65 is substantially perpendicular to the dividing plane, and disposed above, or in close proximity to, the abutment point 75. Placing the latch anchor point above the abutment point results in the latch force acting directly against the opening force F_{O} or a vertical component of the opening force at the abutment portion, and that force is directly transferred to the latch hinge point 65. As the opening force Fₒ may be considered as being directly translated to the valve body at the arm anchor point, such embodiments offer very high strength.

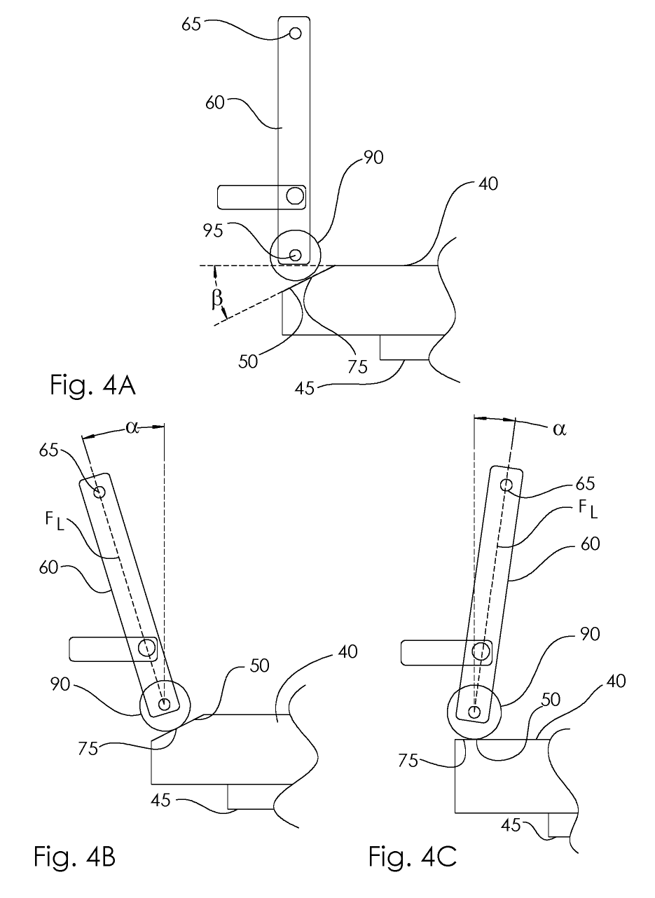

In some embodiments the anchor point 65 is horizontally offset from above the abutment point such that the arm closing force L_{f} and the vertical component of the opening force F_{O} form an angle α therebetween, such as shown by way of example in FIGS. 4B and 4C. Embodiments where the effective angel α is smaller than 12 degrees have negligible effect on the vertical force distribution, and may for practical purposes be considered as equivalent to an anchor point being directly above the abutment point. All effective angles α lower that 45 degrees are explicitly considered. Effective angles α larger than 45 degrees present substantial horizontal force component and thus 45 degrees is considered a practical, if not physical, limit of the angle desired between the arm force L_{f} and the vertical component of the opening force F_{O}.

In the embodiment depicted in FIG. 1, a hinge is utilized to anchor the arm to the valve body, but those skilled in art would recognize that other anchoring arrangements such as a ball and socket joint, saddle joint, and the like, may be equivalently utilized.

An actuator 80 is anchored to the valve, or forms a portion thereof, and acts as a control mechanism for the arm, and thereby for the valve. In the embodiment of FIG. 1 the actuator is coupled to the arm via a pushrod 85. The actuator is disposed to act on the arm and to either maintain the arm in engaged state, or to urge the arm into the disengaged state. In certain embodiments the actuator may further act to release or move the arm from the disengaged state to the engaged state. In certain embodiments, the arm may also act on the clapper, to bring it back into the closed state.

The force applied by the actuator to the arm is enumerated, and often referred to in these specifications, as F_{A}. The mode of operation is dictated by the choice of the arm arrangement against the clapper.

It is an important feature of the aspect of the invention depicted in FIG. 1 and in other selected embodiments, that F_{A} is disposed substantially perpendicularly to the opening force F_{O}, thus in a precisely orthogonal system no opening force component is imparted to the actuator, yet an application of actuator force which is orthogonal to the opening force would displace the arm and allow the clapper to transition to an open state.

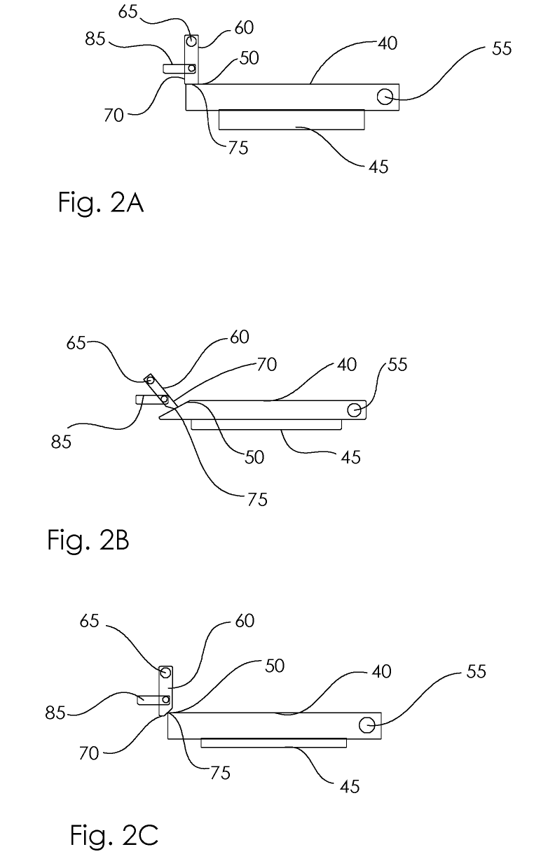

Various structures are possible for the abutment area. FIGS. 2A-C, 3A and 3B, 4 A-C, 6, 7, 8 9A-B, and 10A-C depict schematically several exemplary arrangements of the interface between the arm 60 and the clapper, while the valve is in standby state. For clarity these figures show schematically only few elements of the valve, primarily the clapper with its hinge, the arm and its hinge point, and an optional actuator link. The figures are drawn schematically for illustration purposes, and no proportional or dimensional information is provided thereby.

FIG. 2A depicts an arrangement where the latch hinge point is disposed above the abutment point 75 of the arm closure end 70 with the clapper abutment portion 50. The arm 60 prevents the clapper from rotating into the upper chamber as the arm closure end 70 counteracts the opening force exerted by the fluid on the sealing surface 45. In this example the latch force L_{f} is congruent with the closing force F_{C}, and directly counteracts the opening force F_{O}, by transferring it to the valve body 10 via the arm anchor 65. Moving the arm sideways either left or right, such as by applying a force via actuator link 85 will cause the arm 60 to swing about the arm anchor 65, releasing the clapper 40 to pivot about the clapper hinge 55, in response to the opening force F_{O}. As link 85 is disposed substantially perpendicularly to the opening force F_{O}, no portion of the opening force is transferred to it, and thereby to the actuator 80.

FIG. 2B depicts a similar configuration to the configuration of FIG. 2A, however in this embodiment the clapper abutment area 50 forms an angle α to the sealing surface. The angle α is depicted in FIG. 4A, although FIG. 4A depicts a different abutment arrangement. In such arrangement the clapper imparts some horizontal force denoted F_{H} in FIG. 1A to the arm 60 and thereby to the actuator link 85 and to the actuator 80. Those skilled in the art would recognize that this force is a component of the total opening force acing on the clapper. In such embodiment the actuator is required to maintain a force F_{A} opposing the horizontal force F_{H}, and removal of the actuator force F_{A} will allow the arm to swing to the disengaged state and the clapper to swing open.

The arm 60 in the embodiment depicted in FIG. 2B also depicts an optional construction where the arm anchor 65 is horizontally offset from the abutment point. In contrast to the embodiment of FIG. 2A where a line drawn between the arm anchor point 65 and the abutment point 75 would be substantially perpendicular to the dividing plane, in the embodiment of FIG. 2B the line extending between the arm anchor 65 and abutment point 75 forms an angle to the vertical. Such angle is depicted in FIGS. 4B and 4C, again the different closure end design notwithstanding, and is denoted as angle α. It is noted that embodiments may use different arm closure end configurations and different arm anchor positions, alone or in combination, and the specific embodiments are dictated by engineering and design choices.

In the embodiment depicted in FIG. 2C the arm anchor point 65 is again shown perpendicularly to the clapper abutment point 75, but the arm closure end 70 has an angled face and the abutment point is disposed on the angled face. Similar to the embodiment in FIG. 2B, this arrangement results in a horizontal force F_{H} acting on the arm, and the actuator applies force F_{A} to maintain the arm in the engaged state.

As stated above, the different dispositions of the latch and the abutment are a matter of engineering choice to provide different distribution of forces as desired by the designer. Thus, by way of example, in the configuration of FIG. 2A the clapper opening force is borne by the arm 60, and translated thereby to the arm anchor point 65, and therefrom to the valve body 10. Therefore, no horizontal force component of the opening force urges the arm to open sideways. In this arrangement, the actuator does not need to apply any force to keep the arm engaged with the clapper, and the actuator must urge the arm into disengaged state to allow the valve to open. In contrast, in the embodiment depicted in FIGS. 2B and 2C a component of the opening force is horizontal, and the actuator or other mechanism must counteract this force to maintain the arm closure end 70 engaged with the clapper abutment portion 50. With proper selection of the angled surfaces, or the disposition of the arm anchor, a desired balance may be achieved for the actuator force, and the proportions in the actuator force versus the horizontal component of the opening forces contribute to arm disengagement.

The retainer mechanisms of FIGS. 2A-C already present improvement over the present state of the art. However, for further control of the opening forces certain embodiments of the invention utilize a rolling interface between the arm closure end 65 and the clapper abutment portion 50. Rolling interface may be achieved by a roller rotatable about a roller shaft or pin. The term roller will also relate to a ball. The roller may be disposed on the arm or on the clapper. The roller is disposed to rotate during the disengagement of the arm closure end from the clapper. The use of a roller provides significant mechanical advantage as it offers lower friction resistance between the closure arm and the clapper, thus a roller offers higher reliability, shorter disengagement times, ability to withstand higher opening forces, and lower actuator force required for disengagement.

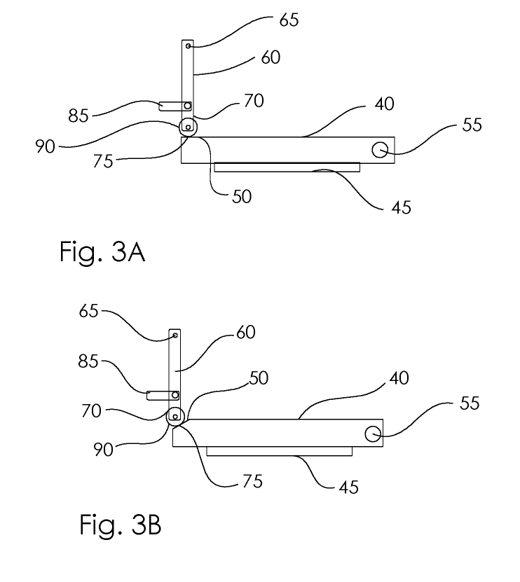

FIG. 3A depicts a first embodiment of an arm equipped with a roller. The similarity of the structure and the operating forces between the embodiments of FIG. 2A and FIG. 3A is clear, however the embodiment of FIG. 3A requires much lower actuator force F_{A} to dislodge the closure arm to a disengaged state. FIG. 3B depicts an embodiment similar in certain respects to the embodiment depicted in FIG. 2C, however this embodiment too enjoys the aforementioned advantages offered by the roller.

FIG. 4A depicts an enlarged view of the portion of the latching mechanism of FIG. 3B. The abutment portion 50 is emphasized by a heavy line. The angle β between the abutment portion and the plane parallel to the sealing surface 45 is shown. The force exerted by the clapper on the roller operates at a right angle to the abutment portion 50 and is thus pointed at the roller pin 95, where the force is divided between a horizontal component and the arm force extending between the arm anchor point and the roller pin. The horizontal component proportional to sin β, will be transformed to a horizontal component which will act to urge the arm to the left. This force requires an opposing force to maintain the arm in engaged state.

It is noted that while the embodiments of 3A and 3B are shown with the arm anchor point being substantially directly above the abutment point, designs with horizontal offset are also considered and will be clear to the skilled in the art in view of the teachings of these specifications.

FIG. 4B depicts an example of an arm engagement where the arm anchor point is disposed at angle α between the vertical and a line extending between the arm anchor and the roller pin 95. A force calculation will show that the horizontal force component on the arm will be reduced as a grows until it reaches a perpendicular angle to the abutment portion 50, and after that point the horizontal force will be reversed, pulling increasingly to the right.

FIG. 4C depicts an enlargement of the arm arrangement where the arm anchor point 65 is disposed horizontally closer to the clapper hinge 55, or stated differently, at standby state the arm 60 extends at an angle α beyond the vertical towards the clapper hinge, which for convenience will be referred to as a negative α. The horizontal force F_{H} urging the arm to the left is a function of sin β, and assuming a small β, the force will also be small. Therefore the actuator force F_{A} required will also be small. It is noted that with very small forces parasitic forces such as the friction between the roller and the roller pin 95 should be considered. However negative alpha arrangements exhibit an advantage: during the valve standby state, where the clapper is closed and the arm is engaged, almost all the opening force is transferred to the arm anchor point 65. However during transition from the engaged state the horizontal component operating on the roller and urging it to push the arm to the left grow rapidly, and therefore while a small, if any, force is required to hold the arm in engaged state, a strong and rapidly growing component of the large opening force operates to disengage the arm after it begins to move, until the closure end disengages from the clapper. Such arm arrangement allows minimal holding forces and very rapid opening of the valve as the arm disengagement action utilizes at least in part the rapidly growing component of the opening force. Negative α is most effective at small β values as the rate of change of the sin function is at its greatest close to zero degrees.

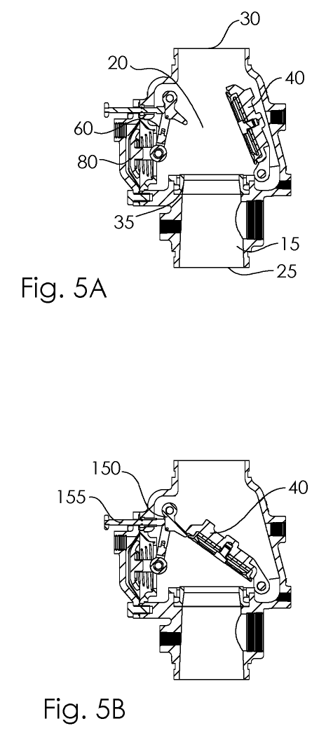

FIGS. 5A and 5B depict side view cross sections of the valve of FIG. 1. FIG. 5A depicts the valve at an activated state. It is seen that the clapper is rotated away from the seat and fluid can flow relatively freely between the inlet and the outlet. Notably, when the clapper rotates upwardly it deflects the reset stop 150 upwards to allow the clapper to swing past it. The reset stop may then free fall into its rest position, as shown.

FIG. 5B depicts the valve at rest, but the clapper is partially open. This state, is normally reached when the valve is activated and the fluid supply is disconnected or the incoming fluid pressure drops below a sufficient level to support the clapper in the raised position. The clapper is prevented from dropping to the full closed state by the reset stop 150. Optionally, reset stop 150 is hinged on the closure arm anchor point 65. Such arrangement reduces manufacturing costs and places the reset stop in a convenient proximity to the clapper trajectory. The reset stop 150 may be moved upward by applying pressure on reset plunger 155, which will result in the reset stop 150 rotating about the arm anchor point 65, rotating the clapper upward. When the reset stop 150 passes past the clapper edge, the clapper falls back onto the valve seat 35, the arm 60 may be reset to its engaged position against the clapper abutment point, fluid pressure restored, and the system will be armed again ready for its next deployment.

In certain embodiments a reset stop 150 is not provided, and the clapper closes by force of gravity, by a spring or by an actuator after disconnection or discontinuance of the fluid supply.

Following closure of the clapper, reverse actuation of the actuator will return the clapper to standby state by engagement of the arm closure end against the clapper abutment point. In certain embodiments the actuating mechanism is capable of urging the arm from the disengaged state to the engaged state causing closure of the clapper. After the clapper has been closed and the arm returned to an engaged state, firefighting fluid pressure may be resumed and the system will again be armed and ready to fight fire.

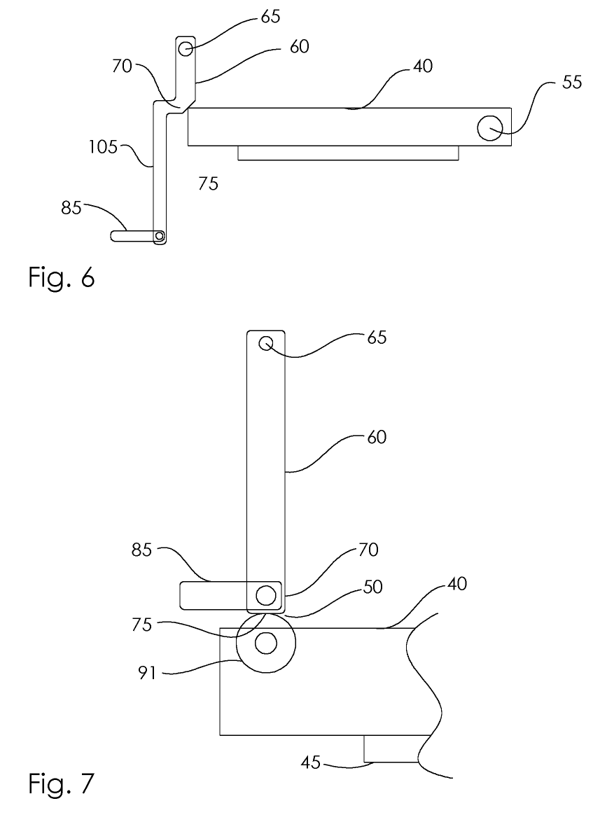

FIG. 6 depicts schematically a closure arrangement where the closure arm 60 is coupled to the actuator via an extension arm 105 extending below the abutment point. Such arrangement may be used to reduce the actuator forces.

The actuator link is but one option through which the actuator 80 may exert force on the arm 60. The coupling between the actuator and the arm may be by direct contact, levers, push rods, cables, wires, and the like. The coupling may be mechanically coupled to the arm or the actuator, or based on intermittent contact at specific times. Those skilled in the art would readily recognize numerous ways to establish the coupling such that force may be applied by the actuator to the arm, to a portion thereof, or to an intermediate structure coupling therebetween.

FIG. 7 depicts schematically an optional arm arrangement where a roller 91 is disposed on the clapper 40 and acts as the abutment portion 50. In the standby mode the closure end 70 of arm 60 contacts the roller 91 at an abutment point 75.

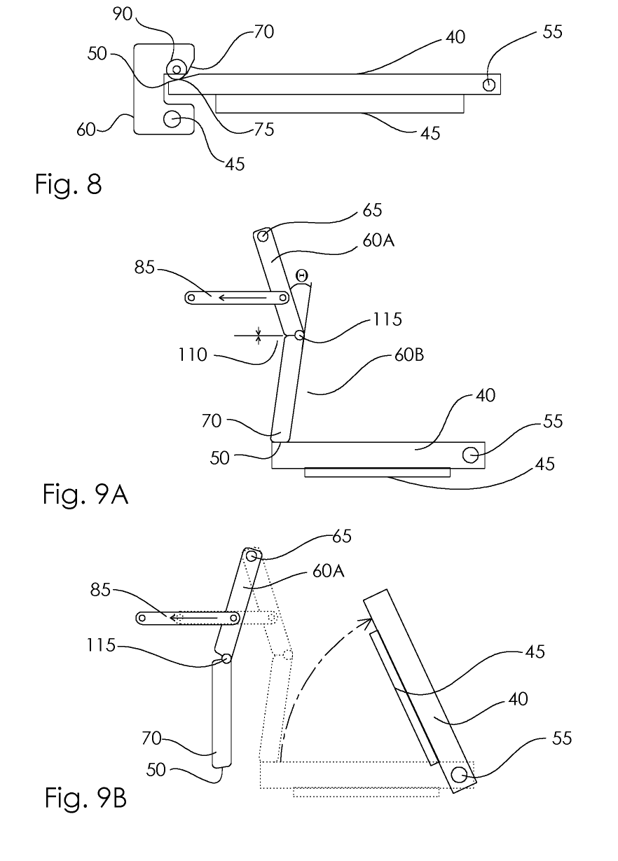

It is important to realize the advantages of a roller at the abutment point to the reliability of the valve operation. These advantages further extend to embodiments where the arm anchor point is in the lower chamber. One example embodiment is depicted in FIG. 8, where the arm anchor point 65 is disposed below the clapper, and the arm is configured to rotate thereabout for releasing the clapper. Those skilled in the art would recognize the rotational forces acting on the arm via the inclined abutment portion 50 of the clapper, to the roller 90, and via the arm body, however a placement of the arm roller on an abutment portion of any configuration as described above is also considered. Other examples of the use of rollers as the point of abutment would be clear to those skilled in art in view of the known art and the teachings of these specifications. In certain embodiments, numerals 90 and/or 91 may also refer to a ball.

FIGS. 9A and 9B depict an optional arm 60 structure. The arm comprises a hinged lever having two sections, 60A and 60B respectively, coupled by a hinge 115 therebetween and rotatable thereabout. FIG. 9A depicts the arm in the engaged state and FIG. 9B depicts the arm in the disengaged state. The two parts 60A and 60B are rotatable relative to each other about the hinge 115. When the two sections are collinear and oppositely extending from the hinge they are said to be “on-center”. The arm 60 further comprises a mechanical stop 110, disposed to limit the relative rotation of two sections when rotating in one direction termed the blocked direction from the on-center position. The two sections are free to rotate over significantly larger arc when rotating in the opposite direction to the blocked direction, termed the non-blocked direction. Oftentimes the arc reaches and sometimes exceeds 90°. When the two sections are rotated farther than the on-center state towards the blocked side, they are said to be locked, and when the arm is in compression, a force is required to move the two sections ‘over the center’ towards the non-blocked direction. When the arm sections are locked, the arm becomes very rigid, and capable of carrying very large loads. FIG. 9A depicts two sections 60A and 60B of the arm 60 in locked state, the arm engaging the clapper 40 and acting to translate the opening forces operating thereupon to the closure arm anchor 65. FIG. 9B depicts the over-the-center lever in the disengaged state, after the Application of relatively small actuating force in the direction indicated by the arrow marked on actuator link rod 85 causes the two arm sections to go ‘over-the-center’ and the arms can then fold towards each other in the opposing direction, and clear the clapper, which may then transition to an open state. This arrangement is yet one more example of an arm arrangement where the arm as a whole is stable, where no force is required by the actuator to maintain the valve in standby state, and where the opening force F_{O} and the actuating force F_{A} are mutually isolated. A roller or a ball similar to those denoted as 90 and 91 may also be utilized.

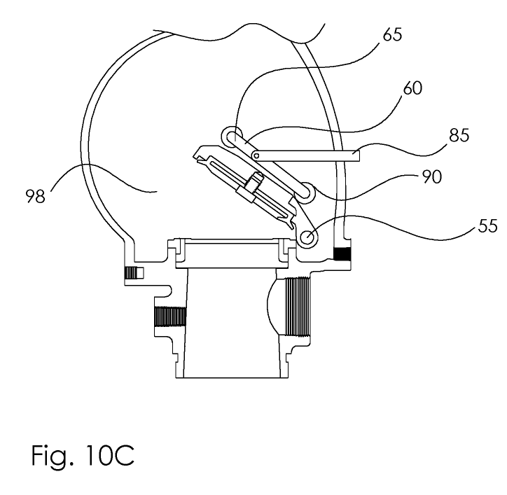

FIGS. 10A-C are directed towards an embodiment which provide reduction of the forces operating on the clapper hinge 55. In the other embodiments disclosed hereabove the clapper opening force F_{CO} is substantially divided between the abutment point 75 and the clapper hinge 55. The embodiment in FIG. 10A places the clapper abutment portion 50 away from the clapper edge, and in some embodiments, above a point at or near the force centroid 42 of the clapper, or stated differently, along the axis of the central opening force F_{CO}. Those skilled in the art would recognize that a force acting in the opposite direction to F_{CO} would distribute equally over the seat, and as such points outside the seat would be subject to minimal if any forces. Such design removes the force component which acts on the clapper hinge 55 in the above depicted embodiments, and thus enables use of a smaller clapper hinge and hinge supports thus providing reduction of at least some of the valve lateral dimensions.

In FIG. 10A the abutment portion is displaced above the rest of the clapper by abutment extension 178, so as to allow the clapper to clear the arm 60 as it swings to the open state, as seen schematically in FIG. 10B which depicts a cross section of a valve embodiment utilizing a clapper and hinge arrangement in accordance with FIG. 10A, the valve shown in the open state. Notably, the arm 60 may be made sufficiently long, such that when the clapper swings into the open state, it clears the arm anchor point 65, while displacing the arm 60, avoiding the need for an abutment extension 178. Yet another optional feature is shown in FIG. 10C, where the retainer mechanism is displaced by the clapper, however the clapper does not clear the arm anchor point 65, and the clapper swing is stopped thereby, or by another mechanical stop such as any part of the latch mechanism. In such embodiments it may be desirable to provide lateral waterway enlargement 98 about the clapper, so as to maintain full flow of the valve, and avoid flow restriction by the clapper which is restricted from swinging completely out of the waterway. Notably such lateral waterway enlargement may be desired in other embodiments as well if any portion of the retainer arrangement does not allow the clapper to swing fully out of the main waterway. The actuator 80 depicted in the figures is a diaphragm 100 actuator. The actuator is coupled by optional rod 85 to the arm. However the skilled in the art would recognize that other actuators may be utilized. By way of example, certain aspects of the invention are beneficial, and extend to, electrically or pneumatically operated valves, wherein other actuators such as a fluid driven or electric motor, a solenoid, a piston, a screw, and the like, exert the desired pressure to push, pull, or rotate the arm.

The depicted examples show horizontally disposed actuator, however the actuator may assume any direction that will exert sufficient proper forces to the arm, either to dislodge the arm from the engaged state, or to oppose the force Fₕ and maintain the arm in place. Notably, in certain embodiments utilizing actuators at different inclinations, the force direction in the examples need to be adjusted to account for the geometries used. Such adjustments are explicitly considered and the invention and claims extend to such embodiments.

The reader is again reminded that the above supplied drawings are provided for illustration purposes, and that the drawings and their components are not necessarily drawn to scale, neither are forces shown to scale, but more to indicate broad general directions.

In this disclosure, unless otherwise stated, adjectives such as “substantially” and “about” that modify a condition or relationship characteristic of a feature or features of an embodiment of the present technology, are to be understood to mean that the condition or characteristic is defined to within tolerances that are acceptable for operation of the embodiment for an application for which it is intended. Furthermore, unless otherwise stated the terms used in this disclosure should be construed as having tolerances which may depart from the precise meaning of the relevant term but would enable the invention or the relevant portion thereof to operate and function as described, and as understood by a person skilled in the art.

It will be appreciated that the invention is not limited to what has been described hereinabove merely by way of example. While there have been described what are at present considered to be the preferred embodiments of this invention, it will be obvious to those skilled in the art that various other embodiments, changes, and modifications may be made therein without departing from the spirit or scope of this invention and that it is, therefore, aimed to cover all such changes and modifications as fall within the true spirit and scope of the invention, for which letters patent is applied.

1. a valve for control of fluid flow in a fire protection system, the valve comprises:
a valve body defining a lower chamber having an inlet and an upper chamber having an outlet;
a valve seat disposed in the valve body, the valve seat defining a sealing port;
a clapper having a bottom and a top, the bottom having a sealing surface, the top having an abutment portion, the clapper being coupled to the valve body by a clapper hinge and being hingedly rotatable thereabout from a closed position where the sealing surface contacts the seat sufficiently to impede fluid flow from the inlet to the outlet, to at least partially open position;
an arm rotatably coupled to the valve body about an arm anchor point, the arm having a closure end, the arm being movable between a disengaged state and an engaged state wherein while the clapper is in the closed state the closure end contacts the abutment portion in at least one abutment point, defining an arm force extending in a direction from the arm anchor point towards the abutment point, for maintaining the clapper in the closed position;
an actuator coupled to the arm for urging the arm or for allowing the arm to move from the engaged state to the disengaged state;
wherein when the clapper is in the closed state the abutment point lies in a geometrical plane substantially parallel to the seat, the geometrical plane separating the lower chamber on one side thereof from the upper chamber on the opposite side thereof, the rotational direction of the clapper from the closed position being initially towards the outlet;
wherein the arm anchor point being disposed in the upper chamber; and,
wherein when fluid under pressure is supplied the inlet and the clapper is in the closed position the fluid exerts thereupon an opening force having a direction, and wherein the included angle between a line congruent with the opening force and a line congruent with the arm force direction or a parallel translation thereof is smaller than 45 degrees.

2. A valve as claimed in claim 1, wherein the actuator imparts an actuator force to the arm between the anchor point and the abutment point.

3. A valve as claimed in claim 2 wherein the arm force direction is perpendicular to the geometrical plane.

4. A valve as claimed in claim 2, further comprising an arm roller coupled to the abutment portion or the closure end, wherein the at least one abutment point is disposed on the roller.

5. A valve as claimed in claim 4 further comprising an arm ball coupled to the abutment portion or the closure end, wherein the at least one abutment point is disposed on the ball.

6. A valve as claimed in claim 4, wherein the arm force direction is substantially perpendicular to the geometrical plane.

7. A valve as claimed in claim 4, wherein the abutment portion is angled to the sealing surface.

8. A valve as claimed in claim 1, wherein the abutment portion is angled to the sealing surface.

9. A valve as claimed in claim 1 wherein the arm further comprises an arm lever extending away from the arm anchor point beyond the closure end, and offset thereto.

10. A valve as claimed in claim 1, wherein the arm force is substantially perpendicular to the geometrical plane.

11. A valve as claimed in claim 10, wherein the abutment portion is angled to the sealing surface.

12. A valve as claimed in claim 1, wherein in the engaged state the arm force forms an angle between the at least a component of the opening force normal to the abutment portion at the at least one abutment point, such that when the arm is moved to the engaged state the arm force would momentarily become parallel to the component of the opening force.

13. A valve as claimed in claim 1, further comprising an arm roller coupled to the abutment portion or the closure end, wherein at least one abutment point is disposed on the roller.

14. A valve as claimed in claim 1, further comprising an arm ball coupled to the abutment portion or the closure end, wherein at least one abutment point is disposed on the ball.

15. a valve for control of fluid flow in a fire protection system, the valve comprises:
a valve body defining a lower chamber having an inlet and an upper chamber having an outlet,
a valve seat disposed in the valve body
a clapper having a bottom and a top, the bottom having a sealing surface, and the top having an abutment portion, the clapper being coupled to the valve body by a clapper hinge and being hingedly rotatable thereabout from a closed position where the sealing surface contacts the seat sufficiently to impede fluid flow from the inlet to the outlet, to at least partially open position;
a hinged arm rotatably coupled to the valve body about an arm anchor point the arm having a closure end and being movable between a disengaged states and an engaged state, wherein when the clapper is in the closed state and the arm is in the engaged state, the arm and the abutment portion contact each other in at least one abutment point for maintaining the clapper in the closed position;
an arm roller or ball coupled to the abutment portion or the closure end, wherein the at least one abutment point is disposed on the roller or ball;
an actuator coupled to the arm for urging the arm or for allowing the arm to move from the engaged state to the disengaged state.

16. A valve for control of fluid flow in a fire protection system, the valve comprises:
a valve body defining a lower chamber having an inlet and an upper chamber having an outlet,
a valve seat disposed in the valve body
a clapper having a bottom and a top, the bottom having a sealing surface, the clapper being disposed within the valve body and being movable from a closed position where the sealing surface contacts the seat sufficiently to impede fluid flow from the inlet to the outlet, to at least partially open position, the clapper top having an abutment portion disposed substantially above the geometrical centroid of the valve seat when the clapper is in the closed position;
an arm rotatably coupled to the valve body about an arm anchor point, the arm having a closure end, the arm being movable between a disengaged state and an engaged state wherein while the clapper is in the closed state the closure end contacts the abutment portion in at least one abutment point, defining an arm force extending in a direction from the arm anchor point towards the abutment point, for maintaining the clapper in the closed position;
an actuator coupled to the arm for urging the arm from the engaged state to the disengaged state;
wherein when the clapper is the closed state the abutment point lies in a geometrical plane parallel to the seat, the plane defining a plane lower side on one side thereof a plane upper side on the opposite side thereof; and,
wherein the arm anchor point being disposed on the upper side of the plane.

17. A valve as claimed in claim 16 wherein the clapper abutment portion is disposed such that a line perpendicular to the valve seat and passing through the valve seat centroid would extend substantially through the abutment point, and wherein the clapper abutment portion extends sufficiently into the upper chamber to allow the clapper to clear the arm or a portion thereof during transition from a closed state to a fully open state.

18. The valve as claimed in claim 17, wherein the clapper is being coupled to the valve body by a clapper hinge and being hingedly rotatable thereabout.

19. A valve as claimed in claim 16, further comprising a lateral waterway enlargement, extending laterally from the waterway in a direction at least partially away from the clapper edge.

20. A valve as claimed in claim 16, further comprising an arm roller or ball coupled to the abutment portion or the closure end, wherein the at least one abutment point is disposed on the roller or ball.
